(19) United States
(12) Patent Application Publication
(10) Pub. No.: US 2025/0193605 A1
(43) Pub. Date: Jun. 12, 2025

(54) ELECTRONIC DEVICE AND METHOD FOR OUTPUTTING SOUND

(71) Applicant: SAMSUNG ELECTRONICS CO., LTD., Suwon-si (KR)

(72) Inventors: Yoonjae LEE, Suwon-si (KR); Donghyun LIM, Suwon-si (KR); Sunmin KIM, Suwon-si (KR); Haekwang PARK, Suwon-si (KR)

(73) Assignee: SAMSUNG ELECTRONICS CO., LTD., Suwon-si (KR)

(21) Appl. No.: 19/060,086

(22) Filed: Feb. 21, 2025

Related U.S. Application Data
(63) Continuation of application No. PCT/KR2023/014254, filed on Sep. 20, 2023.

(30) Foreign Application Priority Data
Nov. 1, 2022 (KR) 10-2022-0143912

(51) Int. Cl. H04R 5/04; H04R 1/26; H04R 1/40; H04R 3/12; H04R 5/02

(52) U.S. Cl. CPC H04R 5/04; H04R 1/26; H04R 1/403; H04R 1/406; H04R 3/12; H04R 5/02; H04R 2203/12; H04R 2205/022

(57) ABSTRACT

An electronic device including a speaker array including a plurality of speaker units, a memory and one or more processors. The plurality of speaker units include a plurality of tweeter units that output high-range sound signals of a critical frequency or above and a plurality of mid-range units that output low-range and mid-range sound signals below the critical frequency. The one or more processors are configured to execute the at least one instruction to control the plurality of tweeter units to, by using a beaming forming method for high-range sound signals, directionally output right (R) channel signals toward a right ear of a user and directionally output left (L) channel signals toward a left ear of the user, and control the plurality of mid-range units to, by using a psychoacoustic model for the low-range and mid-range sound signals, output the R-channel signals and the L-channel signals.

### CROSS-REFERENCE TO RELATED APPLICATION

This application is a continuation application is a continuation application, under 35 U.S.C. § 111(a), of international application No. PCT/KR2023/014254, filed Sep. 20, 2023, which claims priority under 35 U. S. C. § 119 to Korean Patent Application No. 10-2022-0143912, filed Nov. 1, 2022, the disclosures of which are incorporated herein by reference in their entireties.

### TECHNICAL FIELD

The present disclosure relates to an electronic device and a method for outputting sound, and more particularly to, an electronic device including a plurality of speaker units and a method for outputting sound thereof.

### BACKGROUND ART

With the development of electronic technology, various types of electronic devices are being developed. In particular, in order to meet the needs of users who want newer and more diverse functions, sound output devices are being developed to provide sound that corresponds to the characteristics of various contents.

### DISCLOSURE

### Technical Solution

An electronic device according to an embodiment includes a speaker array including a plurality of speaker units, a memory to store at least one instruction and one or more processors to be connected to the speaker array and the memory to control the electronic device. The plurality of speaker units may include a plurality of tweeter units that output high-range sound signals of a critical frequency or above and a plurality of mid-range units that output low- and mid-range sound signals below the critical frequency. The one or more processors are configured to execute the at least one instruction to control the plurality of tweeter units to, by using a beaming forming method for high-range sound signals, directionally output right (R) channel signals (R-channel signals) toward a right ear of a user and directionally output left (L) channel signals (L-channel signals) toward a left ear of the user, and control the plurality of mid-range units to, by using a psychoacoustic model for the low- and mid-range sound signals, output the R-channel signals and the L-channel signals.

The one or more processors may be configured to identify a direction of the user with reference to the electronic device, control the plurality of tweeter units to apply a beamforming filter corresponding to the identified direction of the user for the high-range sound signals, and output R-channel signals and L-channel signals to which the beamforming filter is applied, and control the plurality of mid-range units to apply a Head Related Transfer Function (HRTF) filter corresponding to the identified direction of the user for the low-range and mid-range sound signals, and output R-channel signals and L-channel signals to which the HRTF filter is applied.

The device may further include a microphone array including a plurality of microphones, and the one or more processors may be configured to identify the direction of the user based on a time difference in which a user voice is received through the plurality of microphones, and control the plurality of tweeter units to directionally output R-channel signals toward a right ear of a user and directionally output L-channel signals toward a left ear of the user using a beamforming method for the high-range sound signals based on the identified direction of the user.

The memory may store stores a first beamforming filter corresponding to each of the R-channel signals and the L-channel signals in a first direction and a second beamforming filter corresponding to each of R-channel signals and L-channel signals in a second direction that is different from the first direction with reference to the electronic device. The one or more processors may be configured to, based on the direction of the user corresponding to the first direction, control the plurality of tweeter units to directionally output the R-channel signals toward a right ear of a user and directionally output the L-channel signals toward a left ear of the user by applying the first beamforming filter to the R-channel signals and the L-channels signals of the high-range sound signals, and based on the direction of the user corresponding to the second direction, control the plurality of tweeter units to directionally output the R-channel signals toward a right ear of a user and directionally output the L-channel signals toward a left ear of the user by applying the second beamforming filter to the R-channel signals and the L-channels signals of the high-range sound signals.

The memory may store a first HRTF filter corresponding to each of R-channel signals and L-channel signals in a first direction and a second HRTF filter corresponding to each of R-channel signals and L-channel signals in a second direction that is different from the first direction with reference to the electronic device. The one or more processors may be configured to, based on the direction of the user corresponding to the first direction, control the plurality of mid-range units to output the R-channel signals and the L-channel to which the first HRTF filter is applied by applying the first HRTF filter to the R-channel signals and the L-channel signals of the low-mid-range sound signals, and based on the direction of the user corresponding to the second direction, control the plurality of mid-range units to output the R-channel signals and the L-channel to which the second HRTF filter is applied by applying the second HRTF filter to the R-channel signals and the L-channel signals of the low-mid-range sound signals.

The plurality of speaker units may be configured to include a plurality of first tweeter units disposed in a central portion of the speaker array, a plurality of second tweeter units disposed spaced apart to the right and left of the plurality of first tweeter units, and a plurality of mid-range units disposed on one side of the plurality of second tweeter units.

The plurality of first tweeter units may include three tweeter units disposed in a row, the plurality of second tweeter units may include a right tweeter unit disposed to the right of the three tweeter units and a left tweeter unit disposed to the left of the three tweeter units. The plurality of mid-range units may include a first mid-range unit disposed to the right of the right tweeter unit and a second mid-range unit disposed to the left of the left tweeter unit.

The one or more processors may be configured to obtain the high-range sound signals by applying a high pass filter for sound signals, and obtain the low- and mid-range sound signals by applying a low pass filter for the sound signals.

A method for outputting sound of an electronic device including a speaker array that includes a plurality of speaker units according to an embodiment includes controlling a plurality of tweeter units to, by using a beaming forming method for high-range sound signals, directionally output right (R) channel signals toward a right ear of a user and directionally output left (L) channel signals toward a left ear of the user, and controlling a plurality of mid-range units to, by using a psychoacoustic model for the low-range and mid-range sound signals, output the R-channel signals and the L-channel signals.

According to an embodiment, in a non-transitory computer-readable recording medium storing a computer instruction executable by one or more processors of an electronic device including a speaker array that includes a plurality of speaker units, causes the electronic device to control a plurality of tweeter units to, by using a beaming forming method for high-range sound signals, directionally output right (R) channel signals (R-channel signals) toward a right ear of a user and directionally output left (L) channel signals (L-channel signals) toward a left ear of the user, and control a plurality of mid-range units to, by using a psychoacoustic model for the low-range and mid-range sound signals, output the R-channel signals and the L-channel signals.

### DESCRIPTION OF DRAWINGS

FIGS. 1A, 1B to 1C are views illustrating an implementation example of an electronic device according to an embodiment;

FIG. 2A is a block diagram illustrating configuration of an electronic device according to an embodiment;

FIG. 2B is a block diagram illustrating an implementation example of an electronic device according to an embodiment;

FIG. 2C is a block diagram illustrating an implementation example of an electronic device according to an embodiment;

FIG. 3 is a view provided to explain a method for outputting sound of an electronic device according to an embodiment;

FIG. 4 is a view provided to explain a method for outputting sound of an electronic device according to an embodiment;

FIG. 5 is a view provided to explain a controlling method for an electronic device according to an embodiment;

FIGS. 6A and 6B are views provided to explain an implementation example of beamforming according to an embodiment;

FIGS. 7A, 7B to 7C are views provided to explain an implementation example of beamforming according to an embodiment;

FIGS. 8A and 8B are views provided to explain a method for applying HRTF according to an embodiment; and

FIGS. 9A and 9B are views provided to explain a method for applying HRIR according to an embodiment.

### DETAILED DESCRIPTION OF EMBODIMENTS

The terms used in this specification will be described briefly and the present disclosure will be described in detail.

General terms that are currently widely used are selected as the terms used in the embodiments of the disclosure in consideration of their functions in the disclosure, but may be changed based on the intention of those skilled in the art or a judicial precedent, the emergence of a new technique, or the like. In addition, in a specific case, terms arbitrarily chosen by an applicant may exist, in which case, the meanings of such terms will be described in detail in the corresponding descriptions of the disclosure. Therefore, the terms used in the embodiments of the disclosure need to be defined on the basis of the meanings of the terms and the overall contents throughout the disclosure rather than simple names of the terms.

In the disclosure, the expressions “have”, “may have”, “include” or “may include” indicate existence of corresponding features (e.g., components such as numeric values, functions, operations, or components), but do not exclude presence of additional features.

In the disclosure, the expressions “A or B”, “at least one of A or/and B”, or “one or more of A or/and B”, and the like may include any and all combinations of one or more of the items listed together. For example, the term “A or B”, “at least one of A and B”, or “at least one of A or B” may refer to all of the case (1) where at least one A is included, the case (2) where at least one B is included, or the case (3) where both of at least one A and at least one B are included.

Expressions “first”, “second”, “1st,” “2nd,” or the like, used in the disclosure may indicate various components regardless of sequence and/or importance of the components, will be used only in order to distinguish one component from the other components, and do not limit the corresponding components.

When it is described that an element (e.g., a first element) is referred to as being “(operatively or communicatively) coupled with/to” or “connected to” another element (e.g., a second element), it should be understood that it may be directly coupled with/to or connected to the other element, or they may be coupled with/to or connected to each other through an intervening element (e.g., a third element).

An expression “˜configured (or set) to” used in the disclosure may be replaced by an expression, for example, “suitable for,” “having the capacity to,” “˜designed to,” “˜adapted to,” “˜made to,” or “˜capable of” depending on a situation. A term “˜configured (or set) to” may not necessarily mean “specifically designed to” in hardware.

In some cases, an expression “˜an apparatus configured to” may mean that an apparatus “is capable of” together with other apparatuses or components. For example, a “processor configured (or set) to perform A, B, and C” may mean a dedicated processor (e.g., an embedded processor) for performing the corresponding operations or a generic-purpose processor (e.g., a central processing unit (CPU) or an application processor) that may perform the corresponding operations by executing one or more software programs stored in a memory device.

Singular expressions include plural expressions unless the context clearly dictates otherwise. In this specification, terms such as “comprise” or “have” are intended to designate the presence of features, numbers, steps, operations, components, parts, or a combination thereof described in the specification, but are not intended to exclude in advance the possibility of the presence or addition of one or more of other features, numbers, steps, operations, components, parts, or a combination thereof.

In exemplary embodiments, a ‘module’ or a ‘unit’ may perform at least one function or operation, and be implemented as hardware or software or be implemented as a combination of hardware and software. In addition, a plurality of ‘modules’ or a plurality of ‘units’ may be integrated into at least one module and be implemented as at least one processor (not shown) except for a ‘module’ or a ‘unit’ that needs to be implemented as specific hardware.

Meanwhile, various elements and areas in the drawings are schematically drawn in the drawings. Therefore, the technical concept of the disclosure is not limited by a relative size or spacing drawn in the accompanying drawings.

Hereinafter, an embodiment of the present disclosure will be described in greater detail with reference to the accompanying drawings.

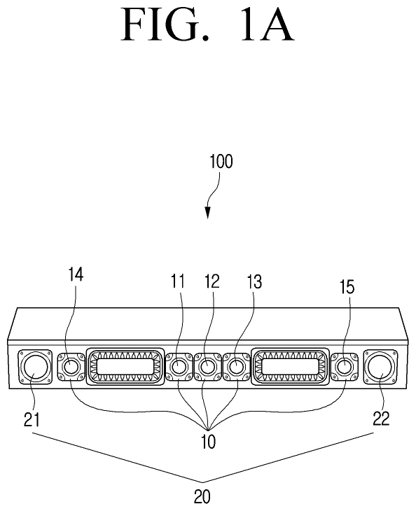

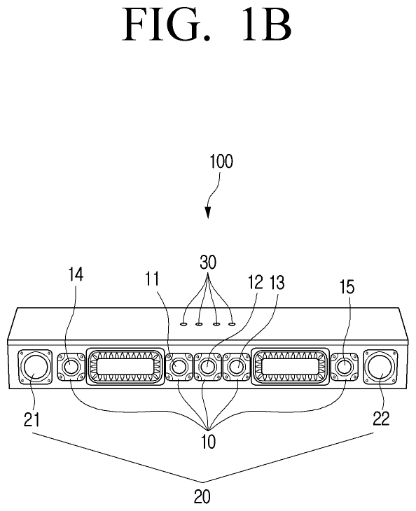

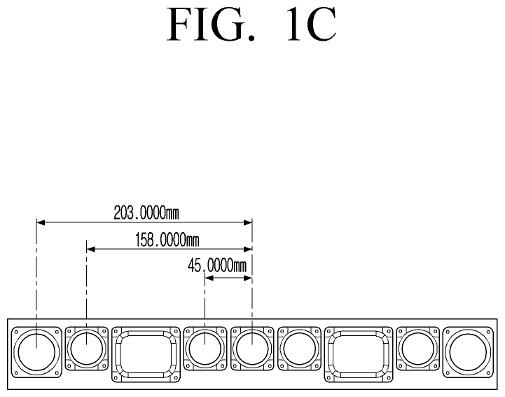

FIGS. 1A to 1C are views illustrating an implementation example of an electronic device according to an embodiment.

An electronic device 100 may include a speaker array including a plurality of speaker units. In this case, the electronic device 100 may be implemented as soundbar, home theater system, one box speaker, room speaker, front surround speaker, etc. However, the electronic device 100 is not limited thereto, and any device including a plurality of speaker units can be the electronic device 100 according to the present disclosure. For example, the electronic device 100 may be implemented as a TV, an audio device, a user terminal, etc. having a plurality of speaker units.

The plurality of speaker units included in the electronic device 100 may have the function of converting electric pulses into sound waves, and may be implemented as a coin type, that is, a dynamic type which is distinguished according to the principle and method of converting electric signals into sound waves. However, the plurality of speaker units are not limited thereto, and the plurality of speaker units may be implemented as a capacitive type, a dielectric type, a magnetostrictive type, etc. within the scope to which the present disclosure is applied.

In addition, the electronics 100 may be implemented in a multi-way manner that divides the playback band into low/mid/high sound ranges, and distributes the divided ranges to suitable speaker units.

For example, in the case of a 2-way manner that distributes the playback band to two types of speakers, the plurality of speaker units may be implemented in a form that includes a tweeter unit and a mid-range unit.

For example, in the case of a three-way manner that distributes the playback band to three types of speakers, the plurality of speaker units may be implemented in a form that includes a tweeter unit for reproducing high-frequency sound signals, a mid-range unit for reproducing mid-frequency sound signals, and at least one woofer unit for reproducing low-frequency sound signals.

FIG. 1A is a view illustrating an implementation example of the electronic device 100.

As shown in FIG. 1A, the plurality of speaker units included in the electronic device 100 may include a plurality of tweeter units 10 that reproduce sound signals of a high frequency band, i.e., high-range sound signals, and a plurality of mid-range units 20 that reproduce sound signals of an intermediate frequency band and a low frequency band, i.e., low- and mid-range sound signals.

For example, the plurality of tweeter units 10 may include a plurality of first tweeter units 11, 12, 13 disposed in a center portion of the speaker array and a plurality of second tweeter units 14, 15 spaced apart to the right and left of the plurality of first tweeter units 11, 12, 13.

In this case, the plurality of first tweeter units 11, 12, 13 may include three tweeter units 11, 12, 13 disposed in a row. The plurality of second tweeter units 14, 15 may include a right tweeter unit 14 disposed to the right of the three tweeter units 11, 12, 13 and a left tweeter unit 15 disposed to the left of the three tweeter units 11, 12, 13. IN other words, the right tweeter unit 14 may be disposed to the right of the rightmost tweeter unit 11 among the three tweeter units 11, 12, 13 disposed in the center portion of the speaker array, and the left tweeter unit 15 may be disposed to the left of the leftmost tweeter unit 13 among the three tweeter units 11, 12, 13 disposed in the center portion of the speaker array. However, the number and/or placement of the plurality of tweeter units is not necessarily limited thereto.

The plurality of mid-range units 21, 22 may be disposed on one side of the plurality of second tweeter units 14, 15. In this case, the plurality of mid-range units 21, 22 may include a first mid-range unit 21 disposed to the right of the right tweeter unit 14 and a second mid-range unit 22 disposed to the left of the left tweeter unit 15. However, the number and placement of the plurality of mid-range units is not necessarily limited thereto.

FIG. 1B is a view illustrating a detailed implementation example of the electronic device 100.

According to an embodiment, as shown in FIG. 1B, the electronic device 100 may further include a microphone array 30 including a plurality of microphones in addition to the speaker array shown in FIG. 1A. The microphone array 30 may be implemented such that the plurality of microphones are spaced at regular intervals. In Although FIG. 1B illustrates that the microphone array 30 includes four microphones, it is not limited thereto. According to an embodiment, the microphone array 30 may be used to identify a user direction.

FIG. 1C is a view illustrating implementation figures of a speaker array according to an embodiment.

According to an embodiment, the electronic device 100 may include a small volume speaker array. For example, the distance between each speaker unit may be as shown in FIG. 1C, but is not necessarily limited thereto.

Meanwhile, recently, the use of content such as metaverse, VR, games, and personal video upload content that can provide a user with stereoscopic sound through a private audio output device such as headphone/headset/earphone is increasing.

When a user uses a private audio output device, the left (L) channel signal enters only the user's left ear, and conversely, the right (R) channel signal enters only the user's right ear. For example, in the case of Binaural Audio Contents, a perfect stereoscopic sound experience is possible when listening with a private audio output device.

Meanwhile, in the case of a general speaker, the signal of the L-channel (or R-channel) enters not only the user's left ear but also the right ear. This phenomenon is known as crosstalk, which can reduce the effect of stereoscopic sound.

Hereinafter, various embodiments that can effectively eliminate crosstalk to maximize the stereoscopic effect in a small volume speaker array will be described.

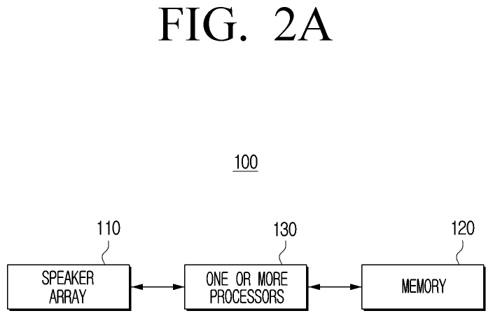

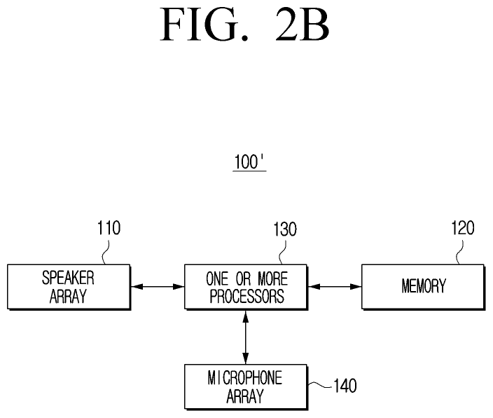

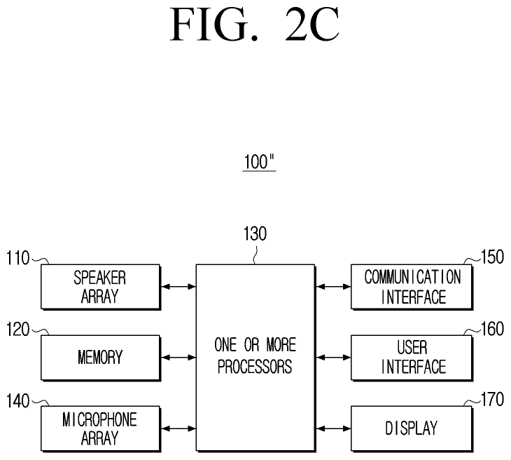

FIG. 2A is a block diagram illustrating configuration of an electronic device according to an embodiment.

According to FIG. 2A, the electronic device 100 includes a speaker array 110, memory 120, and one or more processors 130.

The speaker array 110 includes a plurality of speaker units. According to an embodiment, as shown in FIG. 1A, the plurality of speaker units may include a plurality of tweeter units 10 and a plurality of mid-range units 20. These have been described in detail in FIG. 1A, so further description will be omitted.

The memory 120 may store data required for various embodiments of the present disclosure. The memory 120 may be implemented as a memory embedded in the electronic device 100 or as a memory detachable from the electronic device 100 depending on the data storage purpose. For example, in the case of data for driving the electronic device 100, the data may be stored in the memory embedded in the electronic device 100, and in the case of data for the expansion function of the electronic device 100, the data may be stored in the memory detachable from the electronic device 100.

Meanwhile, the memory embedded in the electronic device 100 may be implemented as at least one of a volatile memory (e.g. a dynamic RAM (DRAM), a static RAM (SRAM), or a synchronous dynamic RAM (SDRAM)), or a non-volatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, a flash memory (e.g. a NAND flash or a NOR flash), a hard drive, or a solid state drive (SSD)). The memory detachable from the electronic device 100 may be implemented in the form of a memory card (e.g., a compact flash (CF), a secure digital (SD), a micro secure digital (Micro-SD), a mini secure digital (Mini-SD), an extreme digital (xD), or a multi-media card (MMC)), an external memory connectable to a USB port (e.g., a USB memory), or the like.

The one or more processors 130 control the overall operations of the electronic device 100. Specifically, the one or more processors 130 are connected to each component of the electronic device 100 to control the overall operations of the electronic device 100. For example, the one or more processors 130 may be electrically connected to the speaker array 110 and the memory 120 to control the overall operations of the electronic device 100. The one or more processors 130 may consist of one or multiple processors.

The one or more processors 130 may execute at least one instruction stored in the memory 120 to perform the operations of the electronic device 100 according to various embodiments.

The one or more processors 130 may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The one or more processors 130 may control one or any combination of the other components of the electronic device, and may perform communication-related operations or data processing. The one or more processors 130 may execute one or more programs or instructions stored in the memory. For example, the one or more processors may perform a method according to an embodiment by executing one or more instructions stored in the memory.

When a method according to an embodiment includes a plurality of operations, the plurality of operations may be performed by one processor or by a plurality of processors. For example, when a first operation, a second operation, and a third operation are performed by the method according to an embodiment, all of the first operation, the second operation, and the third operation may be performed by the first processor, or the first operation and the second operation may be performed by the first processor (e.g., a general-purpose processor) and the third operation may be performed by the second processor (e.g., an artificial intelligence-dedicated processor).

The one or more processors 130 may be implemented as a single core processor including a single core, or as one or more multicore processors including a plurality of cores (e.g., homogeneous multicore or heterogeneous multicore). When the one or more processors 130 are implemented as a multicore processor, each of the plurality of cores included in the multicore processor may include internal memory of the processor, such as cache memory and an on-chip memory, and a common cache shared by the plurality of cores may be included in the multicore processor. Each of the plurality of cores (or some of the plurality of cores) included in the multi-core processor may independently read and perform program instructions to implement the method according to an embodiment, or all (or some) of the plurality of cores may be coupled to read and perform program instructions to implement the method according to an embodiment.

When a method according to an embodiment includes a plurality of operations, the plurality of operations may be performed by one core of a plurality of cores included in a multi-core processor, or may be performed by a plurality of cores. For example, when a first operation, a second operation, and a third operation are performed by a method according to an embodiment, all of the first operation, the second operation, and the third operation may be performed by the first core included in the multi-core processor, or the first operation and the second operation may be performed by the first core included in the multi-core processor and the third operation may be performed by the second core included in the multi-core processor.

In the embodiments of the present disclosure, the processor may mean a system-on-chip (SoC) in which at least one processor and other electronic components are integrated, a single-core processor, a multi-core processor, or a core included in a single-core processor or multi-core processor, and here, the core may be implemented as CPU, GPU, APU, MIC, DSP, NPU, hardware accelerator, or machine learning accelerator, etc., but the core is not limited to the embodiments of the present disclosure. Hereinafter, for convenience of explanation, the one or more processors 130 will be referred to as the processor 130.

FIG. 2B is a block diagram illustrating an implementation example of an electronic device according to an embodiment.

Referring to FIG. 2B, an electronic device 100′ may include the speaker array 110, the memory 120, the one or more processors 130, and a microphone array 140.

The speaker array 110, the memory 120, and the one or more processors 130 are identical to the configuration shown in FIG. 2B and thus, will not be described in detail.

The microphone array 140 may receive a user voice or other sound and convert it into audio data.

In this case, the microphone array 140 may include a plurality of microphones. According to an embodiment, the speaker array 140 may be implemented as the microphone array 30 shown in FIG. 1B, and may be disposed at a preset location of the electronic device 100, for example, in a center portion.

FIG. 2C is a block diagram illustrating an example implementation of an electronic device according to one embodiment.

Referring to FIG. 2C, an electronic device 100″ may include the speaker array 110, the memory 120, the one or more processors 130, the microphone array 140, a communication interface 150, a user interface 160, and a display 170. However, these configurations are only exemplary, and that new configurations may be added in addition to these configurations or some configurations may be omitted in practicing the present disclosure. Meanwhile, the configurations shown in FIG. 2C that are redundant with the configurations shown in FIGS. 2A and 2B will be omitted from further description.

The communication interface 150 includes circuitry. In addition, the communication interface 150 may support various communication methods depending on the implementation example of the electronic device 100.

For example, the communication interface 150 may perform communication with an external device, an external storage medium (e.g. USB memory), an external server (e.g., cloud server), etc. through a communication method such as Bluetooth, access point (AP)-based wireless fidelity (Wi-Fi, wireless local area network (LAN)), Zigbee, wired/wireless local area network (LAN), wide area network (WAN), Ethernet, IEEE 1394, high definition multimedia interface (HDMI), Universal Serial Bus (USB), mobile high-definition link (MHL), audio engineering society/European broadcasting union (AES/EBU) communication, optical communication, coaxial communication, etc.

In this case, the communication interface 150 may receive data from an external device, a server, or the like, and may transmit data to the external device, the server, or the like. For example, the communication interface 150 may receive sound signals including R-channels and L-channels. Here, the sound signals may be stereo signals or multichannel signals.

The user interface 160 includes circuitry. The user interface 160 may receive a user command. To this end, the user interface 160 may be implemented as a device such as a button, a touch pad, a mouse, and a keyboard, or a touch screen that can also perform a display function and a manipulation input function.

The display 170 may be implemented as a display including a self-luminous element or a display including a non-luminous element and a backlight.

For example, the display 170 may be implemented as various types of displays such as a Liquid Crystal Display (LCD), an Organic Light Emitting Diodes (OLED) display, a Light Emitting Diodes (LED), a micro LED, a Mini LED, a Plasma Display Panel (PDP), a Quantum dot (QD) display, a Quantum dot light-emitting diodes (QLED), etc. The display 170 may also include a driving circuit, a backlight unit, and the like, which may be implemented in the form of a-si TFTs, low temperature poly silicon (LTPS) TFTs, organic TFTs (OTFTs), and the like.

According to an embodiment, a touch sensor for detecting various types of touch inputs may be disposed on the front of the display 170.

For example, the display 170 may detect various types of touch inputs, such as a touch input by a user's hand, a touch input by an input device such as a stylus pen, a touch input by certain capacitive materials, and the like. Here, the input device may be implemented as a pen-like input device, which may be referred to by various terms, such as an electronic a pen, a stylus pen, a S-pen, etc. According to an embodiment, the display 170 may be implemented as a flat display, a curved display, a flexible display capable of folding and/or rolling, and the like.

In addition, the electronic device 100″ may further include a camera (not shown), a sensor (not shown), a tuner (not shown), a demodulator (not shown), etc. depending on the implementation example.

According to an embodiment, the processor 130 may control the output using a beamforming method for high-range sound signals and a psychoacoustic model for low- and mid-range sound signals. Here, the high-range sound signals may be sound signals above a threshold frequency, and the low- and mid-range sound signals may be sound signals below the threshold frequency. For example, the processor 130 may apply a high pass filter with reference to the threshold frequency to the input sound signal to obtain a high-range sound signal, and a low pass filter with reference to the threshold frequency to the sound signal to obtain a low- and mid-range sound signal. In some cases, the processor 130 may perform decoding when an encoded signal is input from the outside. For example, when the encoded signal is an SDI signal, the processor 130 may decode the encoded SDI signal and convert it to parallel digital data, and use the above-described filter to divide the audible frequency band into playback ranges and control each playback range to be played by a separate speaker unit.

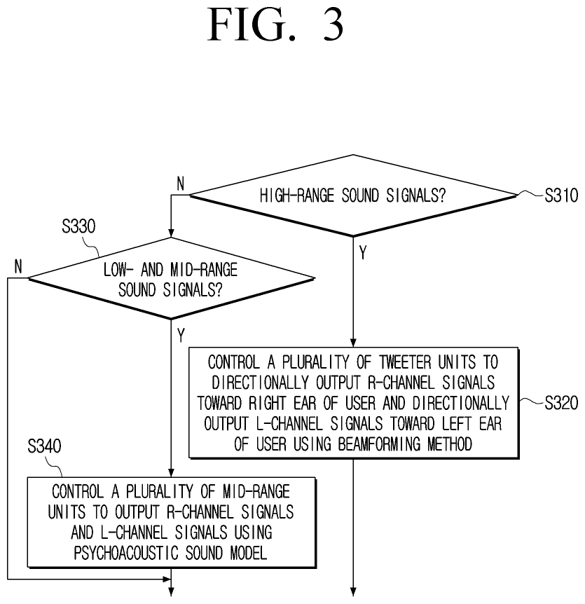

FIG. 3 is a view provided to explain a method for outputting sound of an electronic device according to an embodiment.

According to the embodiment illustrated in FIG. 3, at S320, the processor 130 may control a plurality of tweeter units to directionally output the R-channel signals toward the right ear of the user and directionally output the L-channel signals toward the left ear of the user using a beamforming method for the high-range sound signals (S310: Y). Here, the high-range sound signals may be sound signals above a threshold frequency. The threshold frequency may be determined based on the performance of beamforming of the high-range sound signals. For example, the threshold frequency may be, but is not limited to, 2 kHz.

As mentioned above, the crosstalk cancellation method using the Head Related Transfer Function (HRTF) may not be used for high-range sound signals. This is because it is not easy to control the high-range phase at the desired listening position for high-range sound signals, and the higher the range, the more sensitive it is to the user's listening position (e.g., narrow sweet spot). Accordingly, the speaker array may be configured with the optimal number of tweeter units that reproduce high-range sound signals, and an effective beam forming method may be used even in a speaker array with a small length.

Further, at S340, the processor 130 may control a plurality of mid-range units to output R-channel signals and L-channel signals using a psychoacoustic model for the low- and mid-range sound signals (S330: Y). Here, the low- and mid-range sound signals may be sound signals below a threshold frequency. The psychoacoustic model may include a head-related transfer function (HRTF). The HRTF a three-dimensional function that measures a frequency response according to a direction by playing the same sound in all directions. Specifically, the HRTF is an acoustic transfer function between the sound source and the eardrum, and may contain a lot of information representing the characteristics of the space through which the sound is transmitted, including the time difference between the two ears, the level difference between the two ears, and the shape of the auricle (pinna). In particular, the HRTF includes information about the auricle, which has a decisive influence on the upper and lower sound localization, and since modeling of the rear auricle is not easy, it can be mainly obtained through measurement.

As described above, as for reverse sound signals, the processor 130 may use HRTF rather than beamforming. This is because crosstalk cancellation using HRTF is effective for low- and mid-range sound signals.

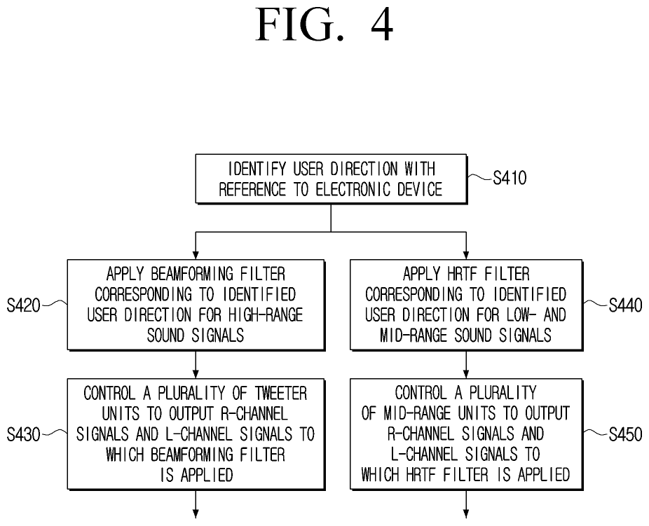

FIG. 4 is a view provided to explain a method for outputting sound of an electronic device according to an embodiment.

According to the embodiment shown in FIG. 4, the processor 130 may identify a user direction (or a user angle) with reference to the electronic device 100 (S410).

For example, the processor 130 may identify a user direction using the user's voice through a plurality of microphones included in the microphone array 140. For example, the user direction may be an angle at which the user is positioned with reference to the electronic device 100. Here, the user's angle may be in the form in which when the angle that is horizontal to the electronic device 100 is 0 degrees, the angle increases counterclockwise up to 360 degrees (same as 0 degrees), but is not limited thereto. For example, the user's angle may be in the form in which when the angle in the front direction of the electronic device 100 is 0 degrees and the clockwise direction is + direction and the counterclockwise direction is − direction, the angle increases up to 180 degrees.

The processor 130 may apply a beamforming filter corresponding to the identified user direction to the high-range sound signals (S420). The beamforming filter may be a filter for processing sound signals to focus them to a specific location. According to an embodiment, the processor 130 may identify a filter coefficient (or parameter) corresponding to the user direction, and apply a beamforming filter including the identified filter coefficient to the high-range sound signals. According to another embodiment, the processor 130 may identify a predesigned beamforming filter corresponding to the user direction, and apply the identified beamforming filter to the high-range sound signals.

According to an embodiment, the processor 130 may identify a beamforming filter corresponding to each of the plurality of tweeter units based on the user direction, and apply a beamforming filter corresponding to the high-range sound signals output through each of the plurality of tweeter units.

Subsequently, the processor 130 may control the plurality of tweeter units to output the R-channel signals and the L-channel signals to which a beamforming filter is applied (S430).

For example, the processor 130 may apply a beamforming filter to the high-range sound signals based on the identified user direction and control the plurality of tweeter units to directionally output the R-channel signals toward the user's right ear and directionally output the L-channel signals toward the user's left ear.

Further, the processor 130 may apply an HRTF filter corresponding to the identified user direction to the low- and mid-range sound signal (S440). Here, the HRTF filter may be a filter that supports HRTF functions. According to an embodiment, the processor 130 may identify an HRTF filter coefficient (or parameter) corresponding to the user direction, and apply an HRTF filter including the identified filter coefficient to the low- and mid-range sound signals. According to another embodiment, the processor 130 may identify a predesigned HRTF filter corresponding to the user direction, and apply the identified HRTF filter to the low- and mid-range sound signals.

According to an embodiment, at S450, the processor 130 may identify an HRTF filter corresponding to each of the plurality of mid-range units based on the user direction, and apply an HRTF filter corresponding to the low- and mid-range sound signals output through each of the plurality of mid-range units.

Subsequently, the processor 130 may control the plurality of mid-range units to output the R-channel signals and the L-channel signals to which an HRTF filter is applied.

For example, the processor 130 may apply an HRTF filter to eliminate crosstalk in the R-channel signals and the L-channel signals based on the identified user direction.

According to an embodiment, the memory 120 may store a beamforming filter corresponding to each of a plurality of user directions and an HRTF filter corresponding to each of the plurality of user directions. For example, the memory 120 may store a first beamforming filter corresponding to each of an R-channel signal and an L-channel signal in a first direction with reference to the electronic device 100 and a second beamforming filter corresponding to each of an R-channel signal and an L-channel signal in a second direction different from the first direction. In this case, the first beamforming filter and the second beamforming filter may include a filter corresponding to each of the plurality of tweeter units.

Further, the memory 120 may store a first HRTF filter corresponding to an R-channel signal and an L-channel signal in a first direction with reference to the electronic device 100 and a second HRTF filter corresponding to an R-channel signal and an L-channel signal in a second direction different from the first direction. In this case, the first HRTF filter and the second HRTF filter may include a filter corresponding to each of the plurality of mid-range units.

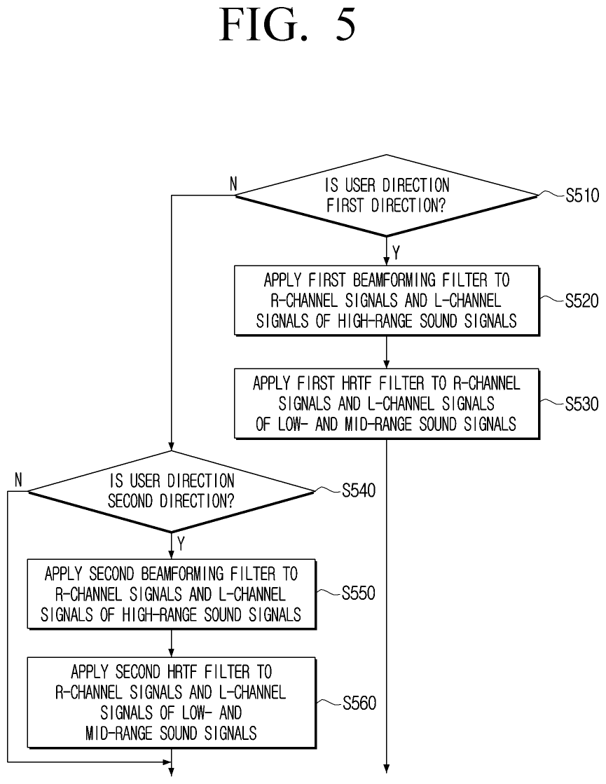

FIG. 5 is a view provided to explain a controlling method for an electronic device according to an embodiment.

According to the embodiment illustrated in FIG. 5, when the user direction corresponds to the first direction (S510: Y), the processor 130 may apply the first beamforming filter to the R-channel signals and the L-channel signals of the high-range sound signals output through the plurality of tweeter units (S520). Accordingly, the R-channel signals may be output directionally toward the right ear of the user positioned in the first direction, and the L-channel signals may be output directionally toward the left ear of the user. Further, at S530, the processor 130 may apply the first HRTF filter to the R-channel signals and the L-channel signals of the low- and mid-range sound signals output through the plurality of mid-range units.

On the other hand, when the user direction corresponds to the second direction (S540: Y), the processor 130 may apply the second beamforming filter to the R-channel signals and the L-channel signals of the high-range sound signals output through the plurality of tweeter units (S550). Accordingly, the R-channel signals may be output directed toward the right ear of a user located in the second direction and the L-channel signals may be output directed toward the left ear of the user. In addition, at S560, the processor 130 may apply the second HRTF filter to the R-channel signals and the L-channel signals of the low to mid-range sound signals output through the plurality of mid-range units.

According to an embodiment, the memory 120 may store a beamforming filter corresponding to each of the plurality of user directions and corresponding to each of the plurality of tweeter units, and an HRTF filter corresponding to each of the plurality of mid-range units. For example, the memory 120 may store, for each of the plurality of tweeter units, the first beamforming filter corresponding to each of the R-channel signals and the L-channel signals in the first direction. The memory 120 may also store, for each of the plurality of tweeter units, the second beamforming filter corresponding to each of the R-channel signals and the L-channel signals in the second direction.

Further, the memory 120 may store, for each of the plurality of mid-range units, the first HRTF filter corresponding to each of the R-channel signals and the L-channel signals in the first direction. The memory 120 may also store, for each of the plurality of mid-range units, the second HRTF filter corresponding to each of the R-channel signals and the L-channel signals in the second direction.

When the user direction is identified as the first direction, the processor 130 may identify the first beamforming filter to be applied to the R-channel signal corresponding to each of the plurality of tweeter units, and apply the identified first beamforming filter to the R-channel signal to be output through each of the plurality of tweeter units. Further, the processor 130 may identify the first beamforming filter to be applied to the L-channel signal corresponding to each of the plurality of tweeter units, and apply the identified first beamforming filter to the L-channel signal to be output through each of the plurality of tweeter units.

Further, when the user direction is identified as the first direction, the processor 130 may identify the first HRTF filter to be applied to the R-channel signal corresponding to each of the plurality of mid-range units, and apply the identified first HRTF filter to the R-channel signal to be output through each of the plurality of mid-range units. Further, the processor 130 may identify the first HRTF filter to be applied to the L-channel signal corresponding to each of the plurality of mid-range units, and apply the identified first HRTF filter to the L-channel signal to be output through each of the plurality of mid-range units.

When the user direction is identified as the second direction, the processor 130 may identify the second beamforming filter to be applied to the R-channel signal corresponding to each of the plurality of tweeter units, and apply the identified second beamforming filter to the R-channel signal to be output through each of the plurality of tweeter units. Further, the processor 130 may identify the second beamforming filter to be applied to the L-channel signal corresponding to each of the plurality of tweeter units, and apply the identified second beamforming filter to the L-channel signal to be output through each of the plurality of tweeter units.

Further, when the user direction is identified as the second direction, the processor 130 may identify the second HRTF filter to be applied to the R-channel signal corresponding to each of the plurality of mid-range units, and apply the identified second HRTF filter to the R-channel signal to be output through each of the plurality of mid-range units. Further, the processor 130 may identify the second HRTF filter to be applied to the L-channel signal corresponding to each of the plurality of tweeter units, and apply the identified second HRTF filter to the L-channel signal to be output through each of the plurality of mid-range units.

According to an embodiment, the memory 120 may store a plurality of beamforming filter sets corresponding to a plurality of user directions. For example, the number of beamforming filters included in a set of beamforming filters be equal to the number of the plurality of tweeter units. Further, each of the plurality of beamforming filters included in the set of beamforming filters may correspond to each of the plurality of tweeter units. In other words, a sound signal passed through the beamforming filter may be output through the tweeter unit corresponding to the beamforming filter.

In other words, when a sound signal passes through a plurality of beamforming filters included in a set of beamforming filters and is output through the plurality of tweeter units, a sound field may be formed such that the sound signal is focused at a distance corresponding to the set of beamforming filters by overlap and offset between the outputted sound signals. To this end, the coefficients of the plurality of beamforming filters included in the set of beamforming filters may be predetermined such that the sound signal is focused at a specific distance.

In this case, the memory 120 may store a set of beamforming filters for the R-channel signals and a set of beamforming filters for the L-channel signals for each of the plurality of user directions.

Here, the coefficients of the plurality of beamforming filters included in the set of beamforming filters for the R-channel signals may be predetermined such that the sound signal is focused at a location of a right the user located in a specific direction with reference to the electronic device 100. Further, the coefficients of the plurality of beamforming filters included in the set of beamforming filters for the L-channel signals may be predetermined such that the sound signal is focused at a location of a left ear of the user located in a specific direction with reference to the electronic device 100.

Accordingly, the R channel signals output after passing through the beam forming filter set for the R channel signals may enter the right ear of the user located in the specific direction with reference to the electronic device (100), and the L channel signals output after passing through the beam forming filter set for the L channel signals may enter the left ear of the user located a specific distance away from the electronic device 100.

The processor 130 may control the plurality of tweeter units to output the R-channel signals and the L-channel signals using a beamforming filter set corresponding to the user direction with reference to the electronic device 100 among the plurality of beamforming filter sets stored in the memory 120.

To this end, the processor 130 may identify a beamforming filter set for the R-channel signals and a beamforming filter set for the L-channel signals corresponding to the user direction among the plurality of beamforming filter sets stored in the memory 120.

Further, the processor 130 may input the R-channel signals to each of the plurality of beamforming filters included in the beamforming filter set for the R-channel signals. For example, the processor 130 may generate a plurality of R-channel signals using a buffer or the like, and input the plurality of R-channel signals to the plurality of beamforming filters. Subsequently, the processor 130 may output the plurality of R-channel signals that passed through the plurality of beamforming filters through the plurality of tweeter units.

In addition, the processor 130 may input the L-channel signals to each of the plurality of beamforming filters each included in the beamforming filter set for the L-channel signals. For example, the processor 130 may generate a plurality of L-channel signals using a buffer or the like, and input the plurality of L-channel signals to the plurality of beamforming filters. Subsequently, the processor 130 may output the plurality of L-channel signals that passed through the plurality of beamforming filters through the plurality of tweeter units.

Accordingly, the R and L sound signals output from the electronic device 100 may be focused on the right and left sides of the user, respectively, to provide a stereophonic sound effect to the user.

The processor 130 may identify the user direction using, for example, a Direction of Arrival (DOA) technique.

For example, the processor 130 may analyze a user voice signal received through a plurality of microphones included in the microphone array 140 to estimate the angle of the user's utterance and identify the user's location based on the angle. In this case, the user voice may include at least one of a random utterance or a preset trigger word.

The DOA technique is a technique for obtaining direction information about a voice signal by utilizing the correlation between voice signals received through each of the plurality of microphones included in the microphone array 140. Specifically, according to the DOA technique, when a voice signal is received at a specific incident angle through the plurality of microphones, the processor 130 may obtain the incident angle of the voice signal based on a delay distance and a delay time according to a difference in the distance at which the voice signal arrives at each microphone, and obtain direction information about the received voice signal based on the obtained incident angle.

For example, the processor 130 may delay voice signals received through the plurality of microphones, and calculate a cross-correlation value between the delayed voice signals. In this case, the processor 130 may determine a delay time at which the cross-correlation value is maximized. The processor 130 may estimate the incident angle of a voice signal using the determined delay time, the speed of the voice signal (e.g., speed of sound), and the distance between the microphones.

For example, the processor 130 may determine the direction in which the voice signal is received based on a time difference between a first reception time at which the voice signal in a specific direction is received by a first microphone and a second reception time at which the voice signal is received by a second microphone. To this end, the memory 120 may store pre-measured correlation data between the reception time difference and the reception direction. For example, the processor 140 may obtain a specific direction (e.g., “90 degrees”) corresponding to the corresponding reception time difference among all directions (directions between “0 degrees” and “360”) from the correlation data based on the reception time difference (e.g., 0 seconds) between the first reception time and the second reception time.

In addition, the processor 140 may obtain direction information about a voice signal using various incident angle estimation algorithms, such as Multiple signal Classification (MUSIC), Generalized Cross Correlation with Phase Transform (GCCPHAT), etc.

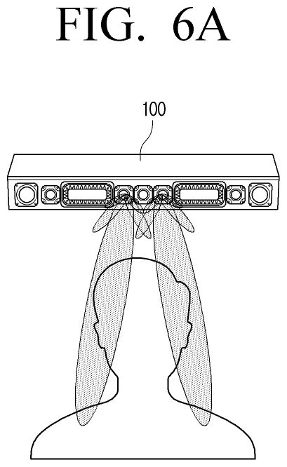

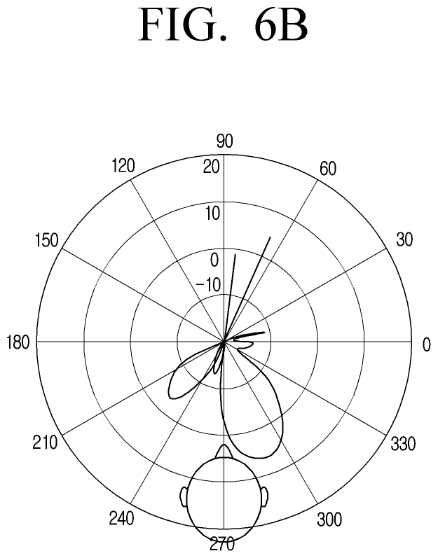

FIGS. 6A and 6B are views provided to explain an implementation example of beamforming according to an embodiment. In FIGS. 6A and 6B, the beamforming characteristics of a sound signal are illustrated in the form of light for ease of understanding.

By applying beamforming to the plurality of tweeter units included in the speaker array as shown in FIG. 6A, the high-range sound signal may be radiated toward the user's left ear and toward the user's right ear in a narrow range, thereby having high directivity characteristics, which can eliminate crosstalk.

FIG. 6B shows the results of beamforming simulation for a 3 kHz signal using five tweeter units as shown in FIG. 1B.

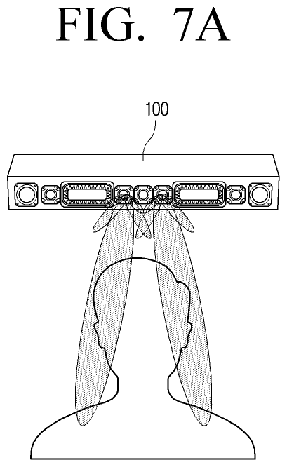

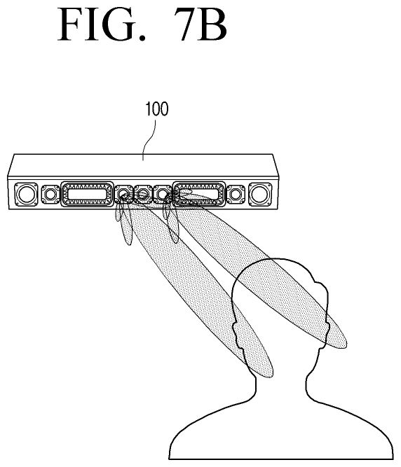

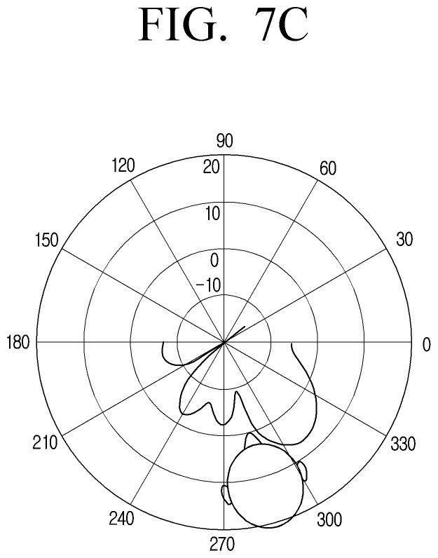

FIGS. 7A to 7C are views provided to explain an implementation example of beamforming according to an embodiment.

According to an embodiment, beamforming may be applied variably depending on the user's location.

For example, as shown in FIGS. 7A and 7B, beamforming may be applied to the plurality of tweeter units to correspond to a case where the user is positioned in front of the electronic device 100 and a case where the user is positioned about 30 degrees to the right, respectively. Accordingly, even if the user's location varies, crosstalk can be eliminated by allowing high-range sound signals to be radiated toward the user's left ear and right ear.

FIG. 7C shows the results of beamforming simulation at the user location in FIG. 7B for a 3 kHz signal using the five tweeter units shown in FIG. 1B.

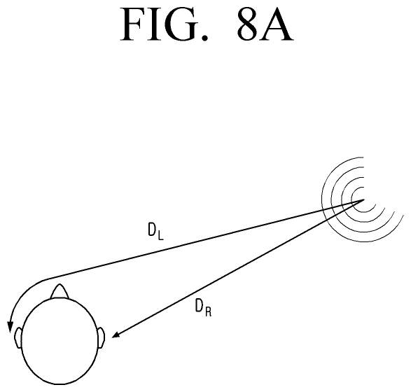

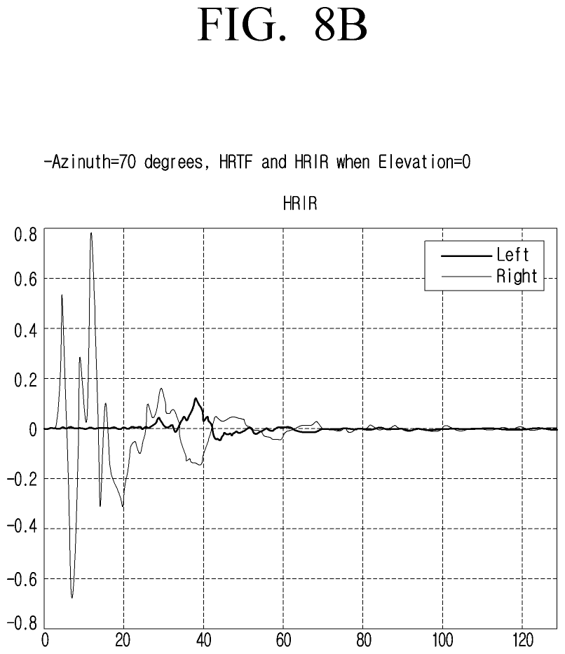

FIGS. 8A and 8B are views provided to explain a method for applying HRTF according to an embodiment.

According to an embodiment, an HRTF filter corresponding to the user direction with reference to a sound source location may be predesigned and applied, as shown in FIG. 8A. In particular, the HRTF filter corresponding to each of the plurality of user directions with reference to the sound source location, for example, the filter value for each tweeter unit, may be predesigned. For example, the Inverse Matrix of the HRTF in the actual listening space may be applied as the filter value.

FIG. 8B is a view illustrating HRTF (e.g., HRIR) according to an embodiment, showing the HRIR corresponding to the L-channel and R-channel when Azimuth=70 degrees and Elevation=0 degrees.

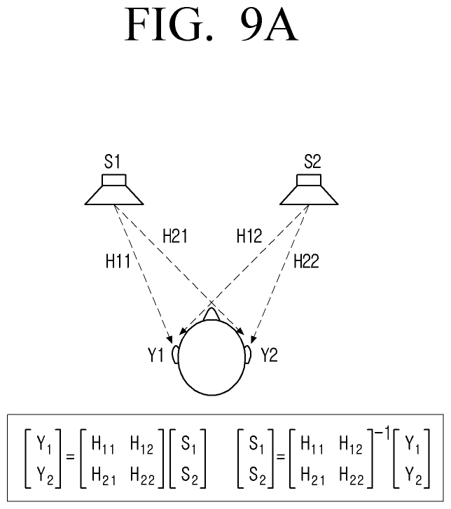

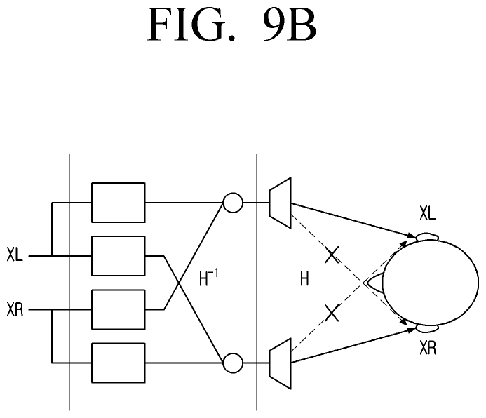

FIGS. 9A and 9B are views provided to explain a method for applying HRIR according to an embodiment.

According to an embodiment, by selecting a head related impulse response (HRIR) corresponding to the user direction and adjusting a delay, crosstalk cancellation suitable for the user's location may be performed as shown in FIGS. 9A and 9B.

For example, the transfer function H(f) of a linear time-invariant system at frequency f can be defined as H(f)=output(f)/input(f). Accordingly, one approach used to obtain the HRTF from a given source location is to measure the head-related impulse response (HRIR), h(t), at the eardrum for an impulse A(t) placed at the source. The HRTF H(f) can be the Fourier transform of the HRIR h(t).

For example, the angle between a plurality of speakers with reference to the user becomes smaller as the distance from the center with reference to the electronic device 100 increases, and as the distance from one speaker becomes farther and farther, gain and/or delay calibration becomes necessary. However, it is of course possible that a pre-calculated value (e.g., a value for which gain and/or delay have been pre-calibrated) is stored to correspond to the user direction and the pre-calculated value corresponding to the corresponding direction can be applied as it is.

According to the various embodiments described above, it is possible to provide a crosstalk cancellation method optimized for a small volume sound reproduction device. Furthermore, it may be possible to provide a stereoscopic sound effect similar to that when wearing earphones/headsets. Further, it may be possible to provide the same level of stereoscopic sound effect without the stuffiness associated with wearing earphones/headsets.

Meanwhile, the methods according to the above-described various embodiments may be implemented in the form of an application that can be installed on an existing electronic device. Alternatively, the methods according to the above-described various embodiments may be performed using a deep learning-based artificial neural network (or deep artificial neural network), i.e., a learning network model.

The methods according to the various embodiments of the present disclosure described above may be implemented only with a software upgrade or a hardware upgrade for an existing electronic device.

In addition, the various embodiments of the present disclosure described above may also be performed through an embedded server provided in the electronic device, or an external server of the electronic device.

Meanwhile, according to an embodiment, the above-described various embodiments may be implemented as software including instructions stored in machine-readable storage media, which can be read by machine (e.g.: computer). The machine refers to a device that calls instructions stored in a storage medium, and can operate according to the called instructions, and the device may include an electronic device (e.g., electronic device A) according to the aforementioned embodiments. In case an instruction is executed by a processor, the processor may perform a function corresponding to the instruction by itself, or by using other components under its control. The instruction may include a code that is generated or executed by a compiler or an interpreter. The machine-readable storage medium may be provided in the form of a non-transitory storage medium. Here, the term ‘non-transitory’ means that the storage medium is tangible without including a signal, and does not distinguish whether data are semi-permanently or temporarily stored in the storage medium.

In addition, according to an embodiment, the above-described methods according to the various embodiments may be included and provided in a computer program product. The computer program product may be traded as a product between a seller and a purchaser. The computer program product may be distributed in a form of a storage medium (e.g., a compact disc read only memory (CD-ROM)) that may be read by the machine or online through an application store (e.g., PlayStore™). In case of the online distribution, at least a portion of the computer program product may be at least temporarily stored in a storage medium such as a memory of a server of a manufacturer, a server of an application store, or a relay server or be temporarily generated.

Further, the components (e.g., modules or programs) according to various embodiments described above may include a single entity or a plurality of entities, and some of the corresponding sub-components described above may be omitted or other sub-components may be further included in the various embodiments. Alternatively or additionally, some components (e.g., modules or programs) may be integrated into one entity and perform the same or similar functions performed by each corresponding component prior to integration. Operations performed by the modules, the programs, or the other components according to the various embodiments may be executed in a sequential manner, a parallel manner, an iterative manner, or a heuristic manner, or at least some of the operations may be performed in a different order or be omitted, or other operations may be added.

Although preferred embodiments of the present disclosure have been shown and described above, the disclosure is not limited to the specific embodiments described above, and various modifications may be made by one of ordinary skill in the art without departing from the gist of the disclosure as claimed in the claims, and such modifications are not to be understood in isolation from the technical ideas or prospect of the disclosure.

1. An electronic device comprising:
a speaker array including a plurality of speaker units, the plurality of speaker units including a plurality of tweeter units that output high-range sound signals of a critical frequency or above and a plurality of mid-range units that output low-range and mid-range sound signals below the critical frequency;
a memory to store at least one instruction; and
one or more processors, to be connected to the speaker array and the memory to control the electronic device, configured to execute the at least one instruction that is stored in the memory to:
control the plurality of tweeter units to, by using a beaming forming method for the high-range sound signals, directionally output right (R) channel signals (R-channel signals) toward a right ear of a user and directionally output left (L) channel signals (L-channel signals) toward a left ear of the user; and
control the plurality of mid-range units to, by using a psychoacoustic model for the low-range and mid-range sound signals, output the R-channel signals and the L-channel signals.

2. The electronic device as claimed in claim 1, wherein the one or more processors are configured to:
identify a direction of the user with reference to the electronic device;
control the plurality of tweeter units to apply a beamforming filter corresponding to the identified direction of the user for the high-range sound signals, and output R-channel signals and L-channel signals to which the beamforming filter is applied; and
control the plurality of mid-range units to apply a Head Related Transfer Function (HRTF) filter corresponding to the identified direction of the user for the low-range and mid-range sound signals, and output R-channel signals and L-channel signals to which the HRTF filter is applied.

3. The electronic device as claimed in claim 2, further comprising:
a microphone array including a plurality of microphones,
wherein the one or more processors are configured to:
identify the direction of the user based on a time difference in which a user voice is received through the plurality of microphones; and
control the plurality of tweeter units to directionally output R-channel signals toward a right ear of a user and directionally output L-channel signals toward a left ear of the user using a beamforming method for the high-range sound signals based on the identified direction of the user.

4. The electronic device as claimed in claim 3, wherein the memory stores a first beamforming filter corresponding to each of the R-channel signals and the L-channel signals in a first direction and a second beamforming filter corresponding to each of the R-channel signals and the L-channel signals in a second direction that is different from the first direction with reference to the electronic device; and
wherein the one or more processors are configured to:
based on the direction of the user corresponding to the first direction, control the plurality of tweeter units to directionally output the R-channel signals toward the right ear of the user and directionally output the L-channel signals toward the left ear of the user by applying the first beamforming filter to the R-channel signals and the L-channel signals of the high-range sound signals; and
based on the direction of the user corresponding to the second direction, control the plurality of tweeter units to directionally output the R-channel signals toward the right ear of the user and directionally output the L-channel signals toward the left ear of the user by applying the second beamforming filter to the R-channel signals and the L-channel signals of the high-range sound signals.

5. The electronic device as claimed in claim 2, wherein the memory stores a first HRTF filter corresponding to each of the R-channel signals and the L-channel signals in a first direction and a second HRTF filter corresponding to each of the R-channel signals and the L-channel signals in a second direction that is different from the first direction with reference to the electronic device; and
wherein the one or more processors are configured to:
based on the direction of the user corresponding to the first direction, control the plurality of mid-range units to output the R-channel signals and the L-channel signals to which the first HRTF filter is applied by applying the first HRTF filter to the R-channel signals and the L-channel signals of the low-range and mid-range sound signals; and
based on the direction of the user corresponding to the second direction, control the plurality of mid-range units to output the R-channel signals and the L-channel signals to which the second HRTF filter is applied by applying the second HRTF filter to the R-channel signals and the L-channel signals of the low-range and mid-range sound signals.

6. The electronic device as claimed in claim 1, wherein the plurality of speaker units are configured to include a plurality of first tweeter units disposed in a central portion of the speaker array, a plurality of second tweeter units disposed spaced apart to a right and a left of the plurality of first tweeter units, and the plurality of mid-range units which are disposed on one side of the plurality of second tweeter units.

7. The electronic device as claimed in claim 6, wherein the plurality of first tweeter units include three tweeter units disposed in a row;
wherein the plurality of second tweeter units include a right tweeter unit disposed to the right of the three tweeter units and a left tweeter unit disposed to the left of the three tweeter units; and
wherein the plurality of mid-range units include a first mid-range unit disposed to the right of the right tweeter unit and a second mid-range unit disposed to the left of the left tweeter unit.

8. The electronic device as claimed in claim 1, wherein the one or more processors are configured to obtain the high-range sound signals by applying a high pass filter for sound signals, and obtain the low-range and mid-range sound signals by applying a low pass filter for the sound signals.

9. A method for outputting sound of an electronic device including a speaker array that includes a plurality of speaker units, the method comprising:
controlling a plurality of tweeter units to, by using a beaming forming method for high-range sound signals, directionally output right (R) channel signals (R-channel signals) toward a right ear of a user and directionally output left (L) channel signals (L-channel signals) toward a left ear of the user; and
controlling a plurality of mid-range units to, by using a psychoacoustic model for low-range and mid-range sound signals, output the R-channel signals and the L-channel signals.

10. The method as claimed in claim 9, further comprising:
identifying a direction of the user with reference to the electronic device,
wherein the controlling a plurality of tweeter units includes controlling the plurality of tweeter units to apply a beamforming filter corresponding to the identified direction of the user for the high-range sound signals, and outputting R-channel signals and L-channel signals to which the beamforming filter is applied; and
wherein the controlling a plurality of mid-range units comprises controlling the plurality of mid-range units to apply a Head Related Transfer Function (HRTF) filter corresponding to the identified direction of the user for the low-range and mid-range sound signals, and outputting R-channel signals and L-channel signals to which the HRTF filter is applied.

11. The method as claimed in claim 10, wherein the electronic device further comprises a microphone array including a plurality of microphones,
wherein the direction of the user is identified based on a time difference in which a user voice is received through the plurality of microphones; and
wherein the controlling a plurality of tweeter units includes controlling the plurality of tweeter units to directionally output R-channel signals toward the right ear of the user and directionally output L-channel signals toward a left ear of the user using a beamforming method for the high-range sound signals based on the identified direction of the user.

12. The method as claimed in claim 11, wherein the electronic device stores a first beamforming filter corresponding to each of R-channel signals and L-channel signals in a first direction and a second beamforming filter corresponding to each of R-channel signals and L-channel signals in a second direction that is different from the first direction with reference to the electronic device; and
wherein the controlling a plurality of tweeter units include:
based on the direction of the user corresponding to the first direction, controlling the plurality of tweeter units to directionally output the R-channel signals toward the right ear of the user and directionally output the L-channel signals toward the left ear of the user by applying the first beamforming filter to the R-channel signals and the L-channel signals of the high-range sound signals; and
based on the direction of the user corresponding to the second direction, controlling the plurality of tweeter units to directionally output the R-channel signals toward the right ear of the user and directionally output the L-channel signals toward the left ear of the user by applying the second beamforming filter to the R-channel signals and the L-channel signals of the high-range sound signals.

13. The method as claimed in claim 10, wherein the electronic device stores a first HRTF filter corresponding to each of the R-channel signals and the L-channel signals in a first direction and a second HRTF filter corresponding to each of the R-channel signals and the L-channel signals in a second direction that is different from the first direction with reference to the electronic device; and
wherein the controlling a plurality of mid-range units include:
based on the direction of the user corresponding to the first direction, controlling the plurality of mid-range units to output the R-channel signals and the L-channel signals to which the first HRTF filter is applied by applying the first HRTF filter to the R-channel signals and the L-channel signals of the low-range and mid-range sound signals; and
based on the direction of the user corresponding to the second direction, controlling the plurality of mid-range units to output the R-channel signals and the L-channel signals to which the second HRTF filter is applied by applying the second HRTF filter to the R-channel signals and the L-channel signals of the low-range and mid-range sound signals.

14. The method as claimed in claim 9, wherein the plurality of speaker units include a plurality of first tweeter units disposed in a central portion of the speaker array, a plurality of second tweeter units disposed spaced apart to a right and a left of the plurality of first tweeter units, and the plurality of mid-range units which are disposed on one side of the plurality of second tweeter units.

15. A non-transitory computer-readable recording medium storing a computer instruction executable by one or more processors of an electronic device including a speaker array that includes a plurality of speaker units, cause the electronic device to:
control a plurality of tweeter units to, by using a beaming forming method for high-range sound signals, directionally output right (R) channel signals (R-channel signals) toward a right ear of a user and directionally output left (L) channel signals (L-channel signals) toward a left ear of the user; and
control a plurality of mid-range units to, by using a psychoacoustic model for low-range and mid-range sound signals, output the R-channel signals and the L-channel signals.

16. The non-transitory computer-readable medium of claim 15, wherein the computer instruction cause the electronic device to:
identify a direction of the user with reference to the electronic device;
control the plurality of tweeter units to apply a beamforming filter corresponding to the identified direction of the user for the high-range sound signals, and output R-channel signals and L-channel signals to which the beamforming filter is applied; and
control the plurality of mid-range units to apply a Head Related Transfer Function (HRTF) filter corresponding to the identified direction of the user for the low-range and mid-range sound signals, and output R-channel signals and L-channel signals to which the HRTF filter is applied.

17. The non-transitory computer-readable medium of claim 16, the electronic device further comprising:
a microphone array including a plurality of microphones,
wherein the computer instruction cause the electronic device to:
identify the direction of the user based on a time difference in which a user voice is received through the plurality of microphones; and
control the plurality of tweeter units to directionally output R-channel signals toward a right ear of a user and directionally output L-channel signals toward a left ear of the user using a beamforming method for the high-range sound signals based on the identified direction of the user.

18. The non-transitory computer-readable medium of claim 17, wherein the memory stores a first beamforming filter corresponding to each of the R-channel signals and the L-channel signals in a first direction and a second beamforming filter corresponding to each of the R-channel signals and the L-channel signals in a second direction that is different from the first direction with reference to the electronic device; and
wherein the computer instruction cause the electronic device to:
based on the direction of the user corresponding to the first direction, control the plurality of tweeter units to directionally output the R-channel signals toward the right ear of the user and directionally output the L-channel signals toward the left ear of the user by applying the first beamforming filter to the R-channel signals and the L-channel signals of the high-range sound signals; and
based on the direction of the user corresponding to the second direction, control the plurality of tweeter units to directionally output the R-channel signals toward the right ear of the user and directionally output the L-channel signals toward the left ear of the user by applying the second beamforming filter to the R-channel signals and the L-channel signals of the high-range sound signals.

19. The non-transitory computer-readable medium of claim 17, wherein the memory stores a first HRTF filter corresponding to each of the R-channel signals and the L-channel signals in a first direction and a second HRTF filter corresponding to each of the R-channel signals and the L-channel signals in a second direction that is different from the first direction with reference to the electronic device; and
wherein the computer instruction cause the electronic device to:
based on the direction of the user corresponding to the first direction, control the plurality of mid-range units to output the R-channel signals and the L-channel signals to which the first HRTF filter is applied by applying the first HRTF filter to the R-channel signals and the L-channel signals of the low-range and mid-range sound signals; and
based on the direction of the user corresponding to the second direction, control the plurality of mid-range units to output the R-channel signals and the L-channel signals to which the second HRTF filter is applied by applying the second HRTF filter to the R-channel signals and the L-channel signals of the low-range and mid-range sound signals.

20. The non-transitory computer-readable medium of claim 15, wherein the plurality of speaker units are configured to include a plurality of first tweeter units disposed in a central portion of the speaker array, a plurality of second tweeter units disposed spaced apart to a right and a left of the plurality of first tweeter units, and the plurality of mid-range units which are disposed on one side of the plurality of second tweeter units.
